(19) United States
(12) Patent Application Publication
(10) Pub. No.: US 2018/0176153 A1
(43) Pub. Date: Jun. 21, 2018

(54) Method of Load-Balanced Traffic Assignment Using a Centrally-Controlled Switch

(71) Applicants: John Reumann, Croton on Hudson, NY (US); Zhang Xu, Croton on Hudson, NY (US); Lazaros Koromilas, Cambridge (GB)

(72) Inventors: John Reumann, Croton on Hudson, NY (US); Zhang Xu, Croton on Hudson, NY (US); Lazaros Koromilas, Cambridge (GB)

(73) Assignee: NoFutzNetworks Inc., Croton on Hudson, NY (US)

(21) Appl. No.: 15/379,802

(22) Filed: Dec. 15, 2016

(51) Int. Cl. H04L 12/935; H04L 12/947; H04L 12/721; H04L 12/851

(52) U.S. Cl. CPC H04L 49/30; H04L 47/2441; H04L 45/38; H04L 49/25

(57) ABSTRACT

This invention provides a new mechanism to load-balance traffic using only a SDN switch with high TCAM space efficiency, avoidance of frequent updates, robustness against accidental or malicious traffic overload, and balancing with respect to any load metric provided said metric is monotonically increasing with traffic rates. Layer for load-balancing logic is folded into the invention by the introduction of L4 matches and return flow-pinning.

### REFERENCES TO RELATED U.S. PATENT APPLICATIONS

This present invention is used in conjunction with the system described in U.S. patent application Ser. No. 15/367,916, “Parallel Multi-Function Packet Processing System for Network Analytics,” describing a parallelized receiver of flows distributed by the apparatus described in this invention.

### TECHNICAL FIELD

This invention pertains generally to the field of network communication and specifically the subfield of centrally controlled and managed networks.

### BACKGROUND OF THE INVENTION

### Technical Problem

This invention applies to a configuration of a network switch with many ports. The switch ports are classified into two port groups: (i) those that are receiving incoming traffic (external ports), and (ii) those that are not (internal ports) over which all incoming traffic will be balanced, subject to liveness of those ports and configuration. Each TCP or UDP connection arriving on external ports, may be forwarded to any internal port, e.g., all internal ports may respond to HTTP for the same public IP address. A traditional network switch must route each incoming packet and send the connection to only one of the ports for each IP address. If all ports connect to devices that are programmed to respond to the same IP addresses, then it is not obvious how to route incoming connections for said public IP address to the internal ports. This work is traditionally implemented in special load-balancer appliances. Such appliances, however, are too complex for the less constrained problems that are better served by a simpler system, such as the system disclosed herein.

Load-balancing itself is not new U.S. Pat. Nos. 7,774,484, 6,996,615, 7,945,678 all relate to various aspects of it. Most of these inventions require special ASICs to operate at line-rate. This present invention achieves highest forwarding rate using OpenFlow switches without specialized hardware. This approach is known as Software-Defined Networks. Various middlebox applications, including load-balancing, have been ported to this new approach [ASTERIX, MICROTE, NIAGARA].

The OpenFlow switch is configured with match patterns in its ternary content addressable memory (TCAM) that maps external ports to internal ports. When a load-balancing mapping from external to internal ports, that maximizes aggregate use of all internal ports is found, then a second problem arises: adapting to traffic shifts.

The challenge is to produce an adaptive system that (i) produces OpenFlow FlowModification to be installed on a switch such that the load measured on internal ports is approximately the same for every port, and (ii) automatically adjusts to traffic and system status changes, such as links and devices coming up and going down or secular changes in user and device populations.

Furthermore, the system should confine the impact of extremely heavy traffic flows that are typically seen in flooding attempts.

This work is complicated by the fact that commodity OpenFlow switches can only accommodate a very limited number of traffic forwarding rules in their TCAM memories, and even if those memories were large, changing those memories is difficult because each change takes effect slowly, if compared to traffic forwarding, and may induce packet loss.

Finally, an adaptive algorithm must prevent thrashing in which flow-assignments change frequently, possibly during the lifetime of individual TCP connections.

### Solution

This invention uses OpenFlow matches with output actions (FlowModifications) to distribute traffic from received traffic matches on external ports to internal ports. The load balancer software collects feedback from servers (connected to internal ports), flow status (the per rule OpenFlow statistics) and port status (aggregate port traffic statistics). This feedback is processed into per-target capacity estimates in terms of traffic volume, which forces an update in flow assignments to internal ports because the new volume estimates may indicate imbalance.

In fact, the switch and balancing systems are initialized with hash-based OpenFlow matches and their derived FlowModifications, which assign inbound traffic to the internal ports solely based on a hash value computed on the packet headers. The initial distribution of flows ignores actual load in the system. This is adjusted in later rounds of the load-balancing algorithm.

The load balancing system measures flow status, port status and server load information from the controlled switch and servers that accept traffic from the internal ports and incorporates these measurements into updated capacity estimates. The flow-assignment are updated based on these new measurements of the actual load taking into account the previous flow-assignment that lead to the updated load distribution.

Based on the measurements, the balancing system determines for each target, how much above or below average load they are running and reshuffles traffic flow assignments by reassigning traffic currently allocated to overloaded targets to those that are underloaded relative to the average of all targets' loads.

If no target is actually running above capacity, no changes are made.

If one or more flows are too large to be assigned to any target without exceeding the capacity of the target, such flows are split to smaller flows by removing wildcards from the flows matches.

Some flows may be so large that even after splitting them on their wildcarded fields, the generated partial flows still exceed the capacity of all internal ports and servers in the system. Such unmanageable “large flows” are sent to designated victim servers and/or ports that are intentionally sacrificed in order to keep the rest of the system stable in the presence of large flows.

As load shifts, the system could be left with highly fragmented rules due to rule splitting. Some flows do not match many packets per second. This invention automatically aggregates small flows which are assigned to the same target port if their aggregate packet pers seconds is well below the target's capacity. This aspect of the invention preserves TCAM rule space.

### Benefits of the Invention

The system balances traffic arriving on the external ports of a common top-of-rack switch over a second set of output ports using no additional hardware beyond the switch.

The system is adaptive to changes in traffic, port status, and load.

Flow matches are loaded into switch TCAMs, therefore this invention achieves very high data rates.

The targets' feedback is based on a reusable API, which allows this invention to be reused in balancing applications with any monotonic load metric not only the CPU and packet load metrics described in the detailed description of this invention.

The system gracefully degrades in the presence of flooding attacks by sacrificing a fixed number of victim servers and/or ports.

The invention uses a small number of load-balancing FlowModifications to achieve a balanced assignment of flows to target ports.

This invention minimizes the rate of TCAM updates.

### BACKGROUND ART

This disclosure considers the following list of references as prior art and explains the differences with and relationships to those related works.

### U.S. Patents

U.S. Pat. No. 6,613,611, “ASIC routing architecture with variable number of custom masks,” Dana How, Robert Osann Jr., Eric Dellinger; CALLAHAN CELLULAR LLC, Lightspeed Semiconductor Corp.; Priority date: Dec. 22, 2000, Filing date: Dec. 22, 2000 Publication date: Sep. 2, 2003, Grant date: Sep. 2, 2003;
U.S. Pat. No. 6,996,615, “Highly scalable least connections load balancing,” Jacob M. McGuire; Cisco Technology Inc.; Priority date: Sep. 29, 2000, Filing date: Dec. 11, 2000, Publication date: Feb. 7, 2006, Grant date: Feb. 7, 2006;
U.S. Pat. No. 7,290,059, “Apparatus and method for scalable server load balancing,” Satyendra Yadav; Intel Corp.; Priority date: Aug. 13, 2001; Filing date: Aug. 13, 2001; Publication date: Oct. 30, 2007; Grant date: Oct. 30, 2007;
U.S. Pat. No. 7,590,736, “Flexible network load balancing,” Aamer Hydrie, Joseph M. Joy, Robert V. Welland; Microsoft Technology Licensing LLC; Priority date: Jun. 30, 2003, Filing date: Jun. 30, 2003, Publication date: Sep. 15, 2009, Grant date: Sep. 15, 2009;
U.S. Pat. No. 7,613,822, “Network load balancing with session information,” Joseph M. Joy, Karthic Nadarajapillai Sivathanup; Assignee: Microsoft Technology Licensing LLC; Priority date: Jun. 30, 2003, Filing date: Jun. 30, 2003, Publication date: Nov. 3, 2009, Grant date: Nov. 3, 2009;
U.S. Pat. No. 7,774,484, “Method and system for managing network traffic,” Richard Roderick Masters, David A. Hansen; F5 Networks Inc.; Priority date: Dec. 19, 2002, Filing date: Mar. 10, 2003, Publication date: Aug. 10, 2010; Grant date: Aug. 10, 2010;
U.S. Pat. No. 7,945,678, “Link load balancer that controls a path for a client to connect to a resource,” Bryan D. Skene; F5 Networks Inc.; Priority date: Aug. 5, 2005; Filing date: Oct. 7, 2005; Publication date: May 17, 2011; Grant date: May 17, 2011;
U.S. Pat. No. 8,416,692, “Load balancing across layer-2 domains,” Parveen Patel, Lihua Yuan, David Maltz, Albert Greenberg, Randy Kern; Microsoft Technology Licensing LLC; Priority date: May 28, 2009; Filing date: Oct. 26, 2009; Publication date: Apr. 9, 2013; Grant date: Apr. 9, 2013;
U.S. Pat. No. 8,676,980, “Distributed load balancer in a virtual machine environment,” Lawrence Kreeger, Elango Ganesan, Michael Freed, Geetha Dabir; Cisco Technology Inc.; Priority date: Mar. 22, 2011, Filing date: Mar. 22, 2011, Publication date: Mar. 18, 2014, Grant date: Mar. 18, 2014;
U.S. Pat. No. 8,959,215, “Network virtualization”, Teemu Koponen, Martin Casado, Paul S. Ingram, W. Andrew Lambeth, Peter J. Balland, III, Keith E. Amidon, Daniel J. Wendlandt; NICIRA Inc.; Priority date: Jul. 6, 2011, Filing date: Jul. 6, 2011, Publication date: Feb. 17, 2015, Grant date: Feb. 17, 2015;
U.S. Pat. No. 9,246,821, “Systems and methods for implementing weighted cost multi-path using two-level equal cost multi-path tables,” Jiangbo Li, Qingxi Li, Fei Ye, Victor Lin; Google Inc.; Priority date: Jan. 28, 2014, Filing date: Jan. 28, 2014, Publication date: Jan. 26, 2016, Grant date: Jan. 26, 2016;
U.S. Pat. No. 9,325,564, “GRE tunnels to resiliently move complex control logic off of hardware devices,” Carlo Contavalli, Daniel Eugene Eisenbud′ Google Inc.; Priority date: Feb. 21, 2013; Filing date: Feb. 21, 2013; Publication date: Apr. 26, 2016; Grant date: Apr. 26, 2016;

### Published U.S Patent Applications

U.S. Patent Application US20150271075A1, “Switch-based Load Balancer,” Ming Zhang, Rohan Gandhi, Lihua Yuan, David A. Maltz, Chuanxiong Guo, Haitao Wu; Microsoft Technology Licensing LLC; Priority date: Mar. 20, 2014, Filing date: Mar. 20, 2014, Publication date: Sep. 24, 2015;
U.S. Patent Application US20140310418A1, “Distributed load balancer,” James Christopher Sorenson III, Douglas Stewart Laurence, Venkatraghavan Srinivasan, Akshay Suhas Vaidya, Fan Zhang; Amazon Technologies Inc.; Priority date: Apr. 16, 2013, Filing date: Apr. 16, 2013, Publication date: Oct. 16, 2014;

### Other Cited Publications

[WILD] R. Wang, D. Butnariu, J. Rexford. OpenFlow-Based Server Load Balancing Gone Wild. in Hot ICE, 2011;
[ASTERIX] N. Handigol, M. Flajslik, S. Seetharaman, R. Johari, and N. McKeown, “Aster*x: Load-balancing as a network primitive,” in ACLD, 2010;
[MICROTE] T. Benson, A. Anand, A. Akella, and M. Zhang, “MicroTE: fine grained traffic engineering for data centers,” in CoNEXT, 2011;
[ANANTA] P. Patel, D. Bansal, L. Yuan, A. Murthy, A. Greenberg, D. A. Maltz, R. Kern, H. Kumar, M. Zikos, H. Wu, C. Kim, and N. Karri. Ananta: Cloud scale load balancing. In Proceedings of SIGCOMM, 2013;
[NIAGARA] N. Kang, M. Ghobadi, J. Reumann, A. Shraer, and J. Rexford. Efficient Traffic Splitting on Commodity Switches. In CoNEXT′15;
[MAGLEV] D. E. Eisenbud, C. Yi, C. Contavalli, C. Smith, R. Kononov, E. Mann-Hielscher, A. Cilingiroglu, B. Cheyney, W. Shang, and J. D. Hosein. Maglev: A Fast and Reliable Software Network Load Balancer. In NSDI, 2016.
[OFSPEC] OpenFlow Switch Specification 1.4.0. [Online]. Available: https://www.opennetworking.org/images/stories/downloads/sdn-resources/onf-specifications/openflow/openflow-spec-v1.4.0.pdf;

The Prior work referenced above relates to this present invention as follows.

U.S. Pat. No. 7,290,059 introduces a balancing system driving a set of second layer dispatchers from a top-level router. The dispatchers maintain a fine-grained (per-connection) dispatch to determine the ultimate destination of each packet while the router updates independently. The dispatchers exchange their dispatch tables frequently. This invention does not divide the problem in the same layered approach as it permits L4 information to be considered at the top-layer router level.

U.S. Pat. No. 8,416,692 introduces a balancing system with multiple balancing layers, each consisting of multiple routers, switches and commodity servers. The balancing decision of the cited patent is made through multiple balancing layers with distributed information, which distributing balancing decisions to all involved entities. This present invention, in contrast, makes centralized balancing decision without the need to maintain such a heavily distributed system. U.S. Pat. Nos. 7,613,822 and 7,590,736 introduce balancing systems that rely on frequent updates of routing tables based on the server status to make packet forwarding decision. In contrast, this present invention updates the FlowModification on a switch slowly without involving any routers.

The problem of splitting traffic over many links as done in the above software-based load-balancers can be offloaded to an SDN switch. One simple, commodity OpenFlow switch can be programmed to distribute traffic to many backend services, links, and middleboxes. U.S. Pat. No. 8,959,215 describes a meta switch that provisions FlowModification down to the TCAM's and routing tables of network elements, which captures the idea of using OpenFlow as a universal routing API. The cited patent does not explain, however, how to generate FlowModification that accomplish a task such as load balancing and which FlowModification should be generated for which switch.

The OpenFlow Specification [OFSPEC] is a an API fully incorporating the concepts of U.S. Pat. No. 8,959,215. This API is implemented in a large percentage of commodity packet switches. OpenFlow provides the ability to match one or multiple fields for each packet, and to specify for each match which actions to execute. For example, OpenFlow would allow matching all TCP packets with destination port 80 and to associate such match with the action of forwarding the packet to physical port 1 (irrespective of any layer 3 routing). The concept of flow defined in OpenFlow, as a set of bit-masks matching a header is the concept of flow used throughout the description of this present invention. The actual definition of flow as a set of packets matching a bit mask pre dates OpenFlow.

OpenFlow enables wildcard matches by using bit masks. For most fields in an OpenFlow match, there are both match and mask can be specified (because the match is intended to be executed on a TCAM). If a certain bit of mask is set to 0, it indicates a wildcard on that bit. For example, in an OpenFlow match that matches tcp source port, the field and the mask of the field may be specified. If the match is set to 2 (0000000000000010 in binary) and the mask is set to 65535 (1111111111111111 in binary), the match matches all packets with tcp source port 2. If the match is set to 2 while the mask is set to 65534 (1111111111111110 in binary), the match matches all packets with tcp source port 2 or tcp source port 3.

OpenFlow implements matching priorities: rules with higher priority are matched first, and only if a piece of traffic is not matched by rules of higher priority are lower priority evaluated. This is a feature that can be used to drastically reduce the number of flow FlowModification required because complex traffic classification can be expressed as a series of alternating positive and negative matches of different priorities [NIAGARA]. Niagara's approach produces substantially less matches than most flow-matching methods including the methods of this invention. However, the highly compressed flow-match sets of Niagara do not lend themselves to partial updates.

There are alternatives to using explicit OpenFlow matches to distribute traffic such as Equal-Cost Multi-Path (ECMP) and Weighted-Cost Multi-Path (WCMP), as in U.S. Pat. No. 9,246,821. The mechanisms work well except for when specific customization needs to be performed or outliers need to be handled.

Ananta [ANANTA], Maglev [MAGLEV] and the invention subject of U.S. Pat. No. 8,676,980 implement load-balancing atop ECPM/WCMP. Those load balancers are front-ended by a layer of ECMP and run a L4 connection table as second layer. In contrast, this invention uses a single stage of OpenFlow switching for load-balancing.

The basic approach of using dynamic OpenFlow matches is described in Aster*x [ASTERIX], which directs the first packets of each flow to the controller and installs micro-flow FlowModification to forward the rest of the packets in the flow to a dynamically chosen destination. This approach is not practical in many use cases as it requires frequent updates to routing tables and places the controller logically on the forwarding path, thus exposing it to DoS attacks.

MicroTE [MICROTE] is a data center traffic distribution solution that operates on traffic forecasts. This differs from the present invention which uses current traffic measurements and optimizes flow-assignments subject to the assumption that traffic remains stable.

U.S. Patent application US20150271075A1 also describes the use of commodity switches with dynamic rules to perform load balancing. The cited work depends on virtual address mappings. Address virtualization is not part of this present invention.

U.S. Pat. No. 9,325,564 describes a method to offload forwarding logic from hardware device to software controller through tunneling. Tunneling allows greater hop count distance between the controlled switch and the targets of load-balancing. Whether the next hop is tunneled or directly-attached to the controlled switch is orthogonal to the content of this disclosure because the nature of attachment is virtualized by the OpenFlow port abstraction.

Finally, the system described in this present patent application is substantially different from randomized load-balancing systems such as U.S. Patent application US20140310418A1 which describes a system that randomly selects a backend server for each connection and sends the connection request to that randomly-chosen backend server.

### DETAILED DESCRIPTION OF THE INVENTION

The preferred implementation of this invention, comprises: an OpenFlow switch, backend servers (the targets), internal and external ports on the switch. The load-balancing rules expressed as OpenFlow flow modifications (FlowModifications). The system measurement relies on traffic statistics all of which are collected using OpenFlow's flow and port status messages, and server metrics which are reported as attribute value pairs or vectors of values representing time series, both of which are signalled via Remote Procedure Calls (RPCs).

A rule is an OpenFlow match that specifies certain fields in a packet with match values and masks. A flow is defined as all traffic that is matched by a rule. An action is directive that instructs a switch to handle a packet by, for example, dropping it, rewriting its destination, or sending it to a specific port. A FlowModification is a rule with actions. The OpenFlow switch collects match statistics on a per FlowModification basis called flow status, which contains statistics such as the number of packets, number of bytes, last seen match, and match install time. The set of actual statistics per switch is vendor-dependent. The set of FlowModifications generated at install time, prior to the collection of statistics, is called the initial rule set.

The weight of a flow is the number of bytes per second observed in a flow. Alternatively, other metrics may be chosen to replace the byte count (e.g., packets, cpu load incurred by processing of the flow). In fact, the weight of a flow in this invention is often an indirectly derived metric that takes CPU load implied by a flow. This is measured by taking the CPU load at a server, and proportionately allocating it to the flows directed to said server in proportion to each flow's contribution to the total traffic that is directed to the server.

A load balancing target is an entity in the system that will receive part of the inbound traffic. For example an OpenFlow port defined by the switch can be a balancing target. Such a port can be an actual hardware port, a port-mirror, or a tunnel, or a group, collectively referred to as ports in the scope of this invention. During the load-balancing process, each target is associated with one bucket, which is container for flows that are assigned to the given target. The weight of a bucket is the summation of weights of all flows assigned to the bucket.

Victim targets are those targets that are chosen to absorb excess traffic. Any target that is not a victim target is defined as a normal target. In the description of the algorithm, each victim target is associated with one victim bucket and each normal target is associated with one normal bucket.

To achieve balance in the sense of this invention is to ensure that each bucket is assigned flows such that the bucket weight is close to target weight of a bucket, which could be a fair share (total traffic divided by number of buckets) or a skewed target. If the weight of a bucket is greater than the target weight of a bucket then said bucket is overloaded. In the reverse case it is said to be underutilized. If the bucket is neither underutilized nor overloaded it is said to be balanced. Overload and underload are subject to some thresholding (allowing for measurement errors of a few percent).

The method of this invention (the “algorithm”) operates in a sequence of phases. At the beginning of each phase there is an assignment of flows to targets and at the end of each phase there is a new assignment of flows to targets and possibly a set of unassigned flows, henceforth called residual flows.

The system may start out with residual flows because, for example, some network link went down between iterations of the load-balancing algorithm. The algorithm generates residual flows by classifying flows that are too large for all buckets as residual flows.

The following conditions are repeatedly checked in the system.
C0 (“UNINITIALIZED”) The system is uninitialized if there is no past flow-status, the flows are defined by initial rule set and all weights of all flows are considered to be zero.
C1 (“BALANCED”) No normal bucket is overloaded, no normal bucket is underutilized and no victim bucket is underutilized and all flows have been mapped. The load balancer will not perform more operations.
C2 (“NORMAL IMBALANCED”) At least one normal bucket is overloaded.
C3 (“NORMAL UNDERUTILIZED”) At least one normal buckets is underutilized and C2 does not hold.
C4 (“VICTIMS IMBALANCED”) At least one victim bucket is overloaded and at least on victim target is underutilized.

The system that is subject of this invention is best understood with the help of FIG. 01, which shows the entire load-balancing system. The system comprises: a switch 0103, a controller 0101 with a load balancer module 0102 and backend servers or other network devices (0110, 0111, 0112). The load balancer generates FlowModifications 0106, which are pushed to the switch by the controller 0101. The switch receives traffic from external ports 0104, 0105, 0106 and traffic is matched against OpenFlow FlowModification 0106 and output to internal ports 0107, 0108, and 0109 by the switch as prescribed in the output actions. The backend servers 0110, 0111, and 0112, connected to internal ports, will receive this traffic and process the incoming packets. One or more load reporter agents 0113 collect load metrics on the servers and send these metrics as reports 0114 to the controller via RPCs.

The overall system is shown in FIG. 2. The system is first initialized 0206 using a novel hash-like technique that biases the initial flow distribution in such a way that known high-traffic ports, e.g., HTTP, are treated separately. A flow chart of the initialization is shown in FIG. 05.

If there are special, high-traffic L4 ports then the system 0402 creates special flows for those Layer 4 ports 0501 and takes one of those matched flows out of the queue 0508 and attempts to split it 0509. For example, a flow that matches Layer 4 port “TCP *1*” could split into two FlowModifications, e.g., “TCP 01*” and the other “TCP 11*.” The two split flows are put back in queue 0509 for later splitting. If there are already enough flows in H 0507, then the initialization exits 0511. If the queue H has no splittable content left 0510, then the system attempts to add more flows by adding flows based on generic matches 0502. An initial wild-card match “*” is repeatedly split as outlined for the port-specific matches before. Take a flow from queue Q 0503, split that flow and reinsert the split results into Q 0504, until there are no more splittable flows in Q 0505 or there are enough flows 0506, at which point initialization exits 0511.

All FlowModifications in the initial set have weight of 1 and in the first round of the load-balancing. The balancer engine distributes these initial flows in a round robin fashion among the buckets as shown in FIG. 6. The flows 0601 are the result of the previous initialization 0511. Each flow 0602 is assigned to exactly one bucket 0603 round robin order so that each bucket receives the same number of flows (+/−1).

Once the initial set of FlowModifications is enforced at the switches, the system will start collecting load measurements 0114 and traffic flow status 0115 which enable calibration and flow-reassignment as described in the following paragraphs.

The current set of FlowModifications 0204 or the set created at the end of the initialization 0604 is fetched and the current rules, match definitions and flow assignments are extracted from it.

The process of regenerating FlowModifications is shown in FIG. 02. Here the configuration 0201 specifies a list of targets to balance (a subset of external ports) 0202. Each such target is represented by a bucket 0207 which contains flows that are forwarded to said target.

The steps of this algorithm are shown in FIG. 03. A module 0301 reads targets from load balancer configuration, which contains information of how to reach the target, e.g. what is the physical port number on switch that is connected to the target, what is the MAC address of the target and so on. Each target is associated with a bucket 0303, which serves as the container for flows during balancing process.

The algorithm queries the switch for flow status of all FlowModifications 0304 parses the those 0302 before merging the current FlowModification 0304 with the buckets that match the output action of this FlowModification 0305. For example, if a FlowModification has actions that specify flow (dl_dst=0:1:2:3:4:5, ip, new_src=128.239.1.3) with action output to port 2, then the flow status matching the flow will be put into the bucket that represents port 2. In addition, the metric impact of the flow assignment at the target (bucket) is measured 0306, e.g., CPU consumption, disk utilization, memory consumption, in order to assign to each flow a weight commensurate with its traffic contribution to the bucket 0307. A flow that contributes 10% to the traffic of bucket B is assigned a weight that is 10% of for instance the CPU load at the target server that is associated with bucket B. This triggers rebalancing flow-assignments 0308 and eventually a new set of flow FlowModifications 0208 which the controller installs on the switch 0103.

Flow assignment 0308 is the algorithm which reassigns flows to buckets based on measured load. The initial check for initialization 0401, C0, is what triggers the already discussed initialization procedure in FIG. 5 at entry point 0402. Normally, there is no need to initialize so the algorithm runs Basic Shuffle 0403, which repeats until C2 no longer holds 0404. The next phase checks if there are any normal buckets that are underutilized but that could be filled with residual flows from other buckets 0405, i.e., C3 is true. The following module 0406 fills underutilized normal buckets which is shown in FIG. 10. If some of the victim buckets are overloaded 0407 while some victim buckets are underutilized, C4, the system balances out the flows across all victim buckets 0408. This phase ends with a check of overall balance C1. If the system is balanced 0409 then the algorithm generates FlowModifications 0208, otherwise, all flows are thrown out and a complete reassignment of all flows 0410 is initiated.

The goal of Basic Shuffle 0403 is to achieve a balance with the least amount of flow-reassignment possible.

FIG. 07 is a flowchart of Basic Shuffle. It runs until all normal buckets are balanced or until there are only residual flows each of which would overload a normal bucket 0702, C2. If there are residual flows that are too large to be assigned those are assigned to victim buckets in round robin order 0701. If the normal buckets are not balanced, the balancer selects the bucket with the greatest weight 0703. The bucket is checked for overload 0704 and if it is overloaded, the bucket will be reduced by flow removal 0706 until it is no longer overloaded. If instead the bucket is underutilized, C3, 0705 it is scheduled to receive flows from the residual flows 0707.

After each phase the balancer checks again if the normal buckets are still imbalanced, C2, 0702 and retries Basic Shuffle until the imbalance vanishes or until there are no options for local improvement.

The reduction of an overloaded bucket 0706 is shown in greater detail in FIG. 08, in which the algorithm removes flows 0801 in descending flow weight order, adds those flows to the residual flows set 0802 until the current bucket is no longer overloaded 0704.

FIG. 09 shows the opposite situation, an underutilized bucket, which is augmented with additional flows 0707 that are removed from residual flows in ascending weight order 0902 from the residual flows until the bucket is no longer underutilized 0705 or there are no more residual flows 0901.

All flows that are still in the residual flow set even after backfilling all underutilized normal buckets (described in the previous paragraph) are subsequently allocated to victim buckets 0701 in round robin order starting with the largest residual flows first. This stable sorting-based approach minimizes the total number of flows reassignments.

There may still be underutilized normal buckets per C3, because the overload reduction 0706 freed some buckets of flows parts of which would have comfortably fit into another bucket after the other bucket's own overload reduction 0706 freed up capacity in the other bucket. In this case those partial flows can be retrieved in a final pass from the victim buckets 0406. The move from victim targets to normal buckets proceeds in order of the smallest flows that are currently assigned to victim buckets. This procedure repeats until condition C3 no longer holds or there are no more flows in the victim buckets or the current flow cannot be added to normal buckets without overloading them. Only existing capacity in normal buckets are backfilled in this module; no new capacity is freed up in normal buckets.

Since most flows in the victim buckets will be too large to fit into normal buckets they are split large victim flows into smaller fractional flows by fixing certain bits that wildcarded in the large flow that is currently assigned to the victim bucket. For example, the flow “*1” would become two smaller flows “01” and “11.” Flow splitting itself is not new [WILD] but using flow-splitting to back-fill otherwise underutilized buckets from a set over-sized flows in a load-balancing system is.

The process of splitting larger flows into several smaller ones and using those to back-fill gaps in underutilized normal buckets is shown in FIG. 10. If there are underutilized normal buckets and there is load in victim buckets C3, 1005, then the following procedure is executed. The least weight flow is chosen from the victim buckets 1001 and the normal bucket with least weight will be selected 1002. The chosen flow will be added to the selected bucket 1003 and the bucket will be checked if it is overloaded after the addition 1004. If not, the balancer will check if condition C3 still holds 1005. If so the loop continues with the next smallest flow from the victim buckets. If condition C3 no longer holds, then the sub module exists and the algorithm moves on 0407. If there are only small gaps, i.e., the next smallest flow of 1001 would overload the bucket 1004, then the algorithm will attempt splitting the large flow if there are enough wildcarded bits in it 1007. If so, the flow will be split into N small flows 1008 one of which is added to the normal bucket and the other N−1 will be added back to the victim bucket 1009. After splitting a flow with weight W into N flows, every small partial flow will get a pseudo weight of W/N. If those split flows are still too large to fit into any underutilized normal bucket, then the flow remains in original form in the victim bucket and the module terminates 0407. At this point there are no gaps in the normal buckets that could be filled by splitting flows of the victim buckets.

If the normal buckets are now balanced or no improvement is possible, then the victim balancing module 0408 reassigns flows among victims only. The algorithm removes flows from victim buckets, and uses round robin based approach to assign the flows, starting with the largest flow. This step is necessary due to the possible split-induced size reduction of some victims buckets.

The details of the victim balancing algorithm (FIG. 11) are to first remove all flows that are currently assigned to victim buckets 1101 and sort them based on weight in descending order 1102. Then find the least loaded bucket B 1103 and add the least weight flow 1104 to the bucket B. If there are more flows that need to be assigned to victims 1105 then repeat the steps from finding the least loaded bucket B 1103 until this condition 1105 no longer holds.

After all previous balancing modules complete it is still possible that the buckets are imbalanced, C1 is still false, without any option for local balance improvement. In this case, Basic Shuffle has failed and the algorithm will perform an expensive Complete Reassignment of flows 0410, unless the Complete Reassignment algorithm has already been run on this iteration of the load-balancer.

On first failure of Basic Shuffle the Complete Reassignment algorithm is executed which is the same as the algorithm of FIG. 11 but with normal buckets replacing victim buckets in 1101 and 1103.

Once Complete Reassignment completes, Basic Shuffle is re-run on the reassignment of flows 0403. If this second invocation of Basic Shuffle fails again then the system will enforce the follow assignment resulting from the first (failed) run of Basic Shuffle during the current iteration of the load-balancer algorithm 0208.

After the flow assignment completes each bucket's flows can be mechanically translated into an OpenFlow FlowModification. The bucket itself corresponds to an output action, while the flow can be directly translated to a match. The translation of a bucket to an action works as follows: each bucket is associated with one or more OpenFlow ports, e.g. port 4. Assume it contains the flow of all traffic that matches“TCP destination port: 80,” Then the combination of the bucket and the flow results becomes FlowModification:

“tcp,tp_dst=80, action=output:4”.

The following description aids in the understanding of flow splitting and aggregation:

Flows are generated by bit masks on packet headers, it is easy to divide large flows to multiple small ones [WILD] or to aggregate small flows to a single large flow. For example, in binary format, for a flow with TCP source port value “011” and source port mask “011,” if it is too large to fit into any bucket, the balancer can split it into two flows: 1. TCP source port value “011” and source port mask “111”; 2. TCP source port value “111” and source port mask “111”. When a flow is split into two, it is assumed that each child flow gets half of the weight of parent flow. Of course, this is a guess, but fortunately not a bad one.

The reverse is also possible. Two flows can be combined into one if the bit vectors of the two matches are adjacent, i.e. there is only one bit difference between the bit vectors of the two FlowModification. The weight of aggregated flow is the summation of the weight of the two small flows. For example, in binary, for two flows with one matches TCP source port “011” with mask “111” and another flow matches TCP source port “111 with mask “111”, they can be aggregated to a single flow that matches TCP source port “011” with mask “011.” The flow aggregation can be performed after flow assignment is done. The flows assigned to the same bucket can be aggregated when their match bit vectors are adjacent.

This present invention contains an enhancement for its use in passive traffic analytics solutions in which the external ports receive both directions of traffic from a fiber tap for online inspection. The problem in these applications is that both directions of a TCP or UDP connection need to be received by the same destination processor. So far, the load-balancing strategies of this invention have ignored the problem of how to assign the reverse flow, as all ports were considered equal. Without the following addition the method would generate flow modifications that send forward and reverse traffic on a single TCP connection to two different devices.

This problem is solved by return flow pinning: For each TCP flow the reverse flow is created by swapping source and destination (both Layer 3 and Layer 4) and then inserting the reversed flow match explicitly with higher priority in the FlowModifications that are generated at the output stage of the load-balancing algorithm at step 0208 in FIG. 4. This solution is a unique feature of this invention that is absent from related work because in those systems forward and reverse path do not need to traverse the same path. The term “pin” refers to the destination output target port of the forward and reverse flow being the same.

The reversal is applied to flows where the IP source address is smaller than the IP destination address, or if they are both the same and the protocol source (e.g., TCP source port) is less than the protocol destination.

The relationship between forward and reverse flow match is shown in FIG. 12. 1201 is the pair of match and mask in the forward direction and a priority 1219. The generated reverse flow 1202 has priority 1220 which is greater than 1219, for example a REVERSE_FLOW_PRIO that is fixed by received configuration.

The forward source IP address 1203 and protocol source 1205 in the forward flow 1201 are inserted in the destination IP field 1212 and the protocol destination 1214 of the reverse flow 1202. Analogously, the destination IP address 1204 and destination protocol address 1206 in the forward flow 1201 are inserted in the source ip field 1211 and source protocol address field 1213 of the reverse flow. The bit masks for the field are swapped likewise in that source and destination IP masks are swapped (1207 moves to 1216, 1208 moves to 1215) and the source and destination protocol address masks are swapped (1209 moves to 1218 and 1210 moves to 1217) in the reverse flow. Other fields of the packet headers in the flow-definition remain the same in the reverse flow.

The so-generated reverse flow is associated with the same action as the forward flow and inserted as a FlowModification (flow plus action) in the controlled switch.

Upon removal of a forward flow an auto-generated reverse flow is removed as well. This can be automated by ensuring that the priority field of reverse flows is always a unique number reserved for reserved flows, or by labelling such flows with a specific OpenFlow cookie. In either case, the unique label makes re-generation and the deletion of the reverse flow for a forward flow a safe operation.

Occasionally, it may be necessary to add more fields to the direction identification of a flow such as physical source port and physical destination port.

The entire system operates by periodically running the algorithm of FIG. 4 controlling a controlled OpenFlow switch, and receiving load measurements 0114 from measurement agents and all of the switch statistics on each round.

### Examples

One example use of the methods of this invention is to use a switch controlled by the invention as a load-balancing front-end to a set of identically configured firewall routers.

Another example use of this system as a load-balancing front-end to distribute packets to an Intrusion detection system, as is described in the concurrently submitted related U.S. patent application Ser. No. 15/367,916.

Another example use is one in which the system of this invention is used as a front-end to a conventional Layer 4 load-balancer system as an alternative to some of the multi-tiered load-balancer systems described as prior art.

### BRIEF DESCRIPTION OF THE DRAWINGS

FIG. 01 shows the system architecture.

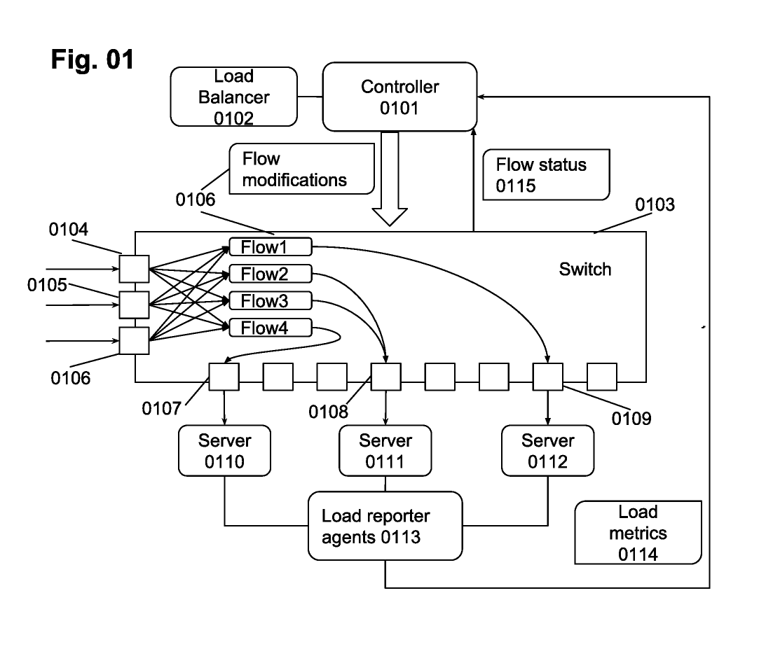

FIG. 02 shows the components of the load-balancing algorithm.

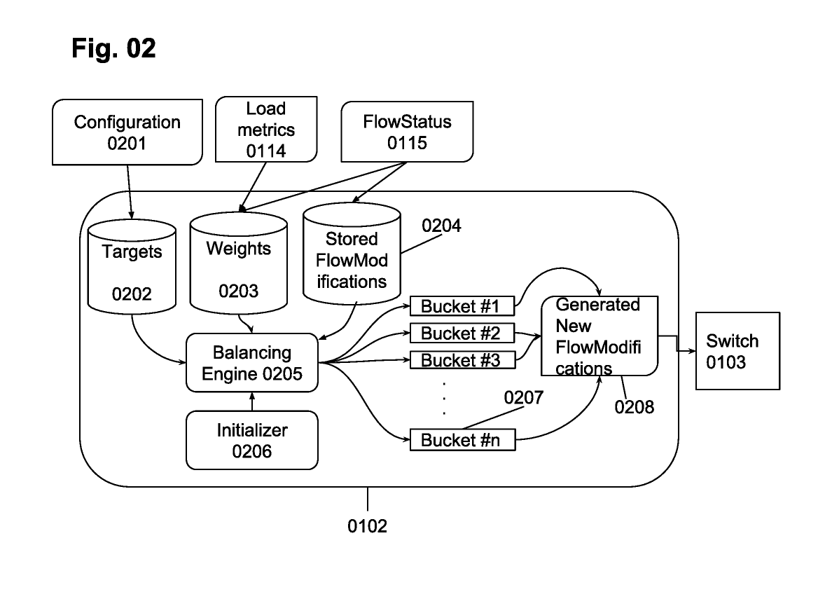

FIG. 03 is a flowchart of the top-level logic of the load balancing algorithm.

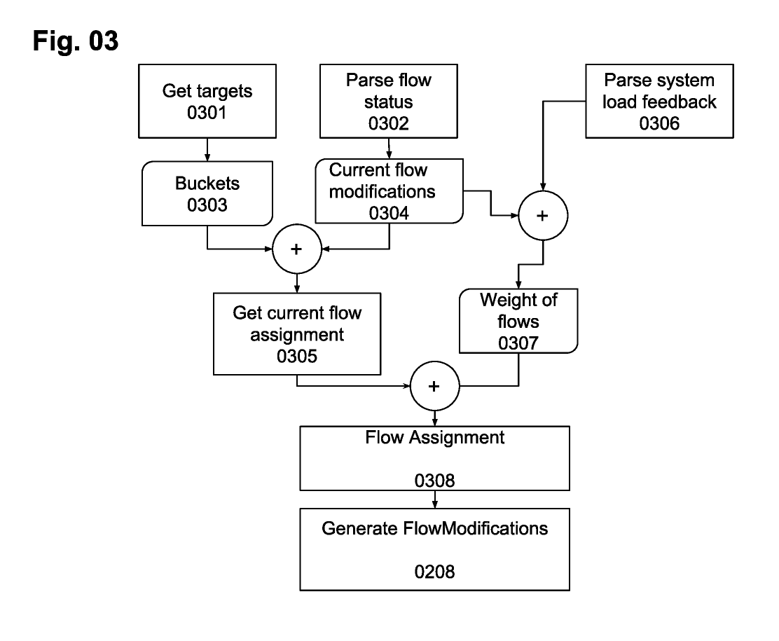

FIG. 04 shows the core balancing algorithm used to assign flows to buckets.

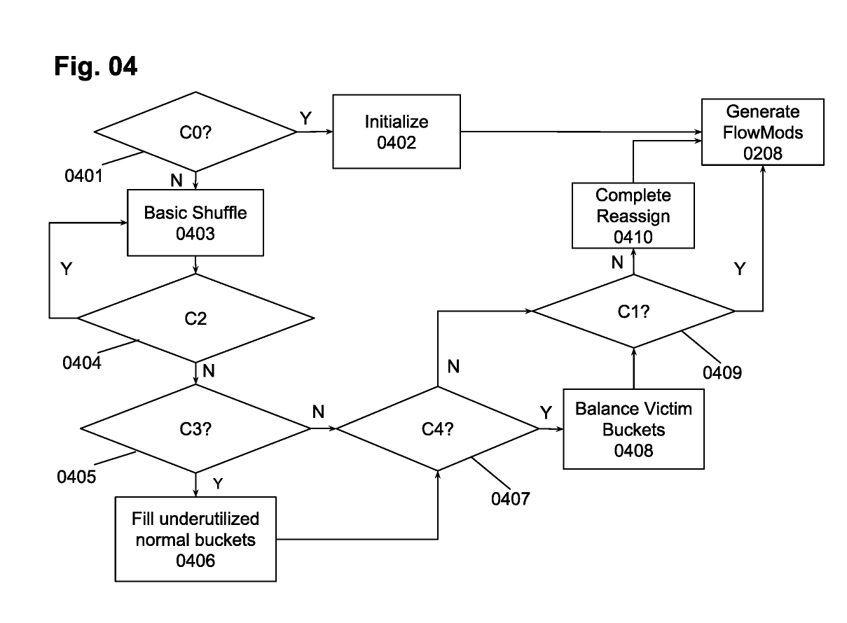

FIG. 05 shows how initial rule set is generated.

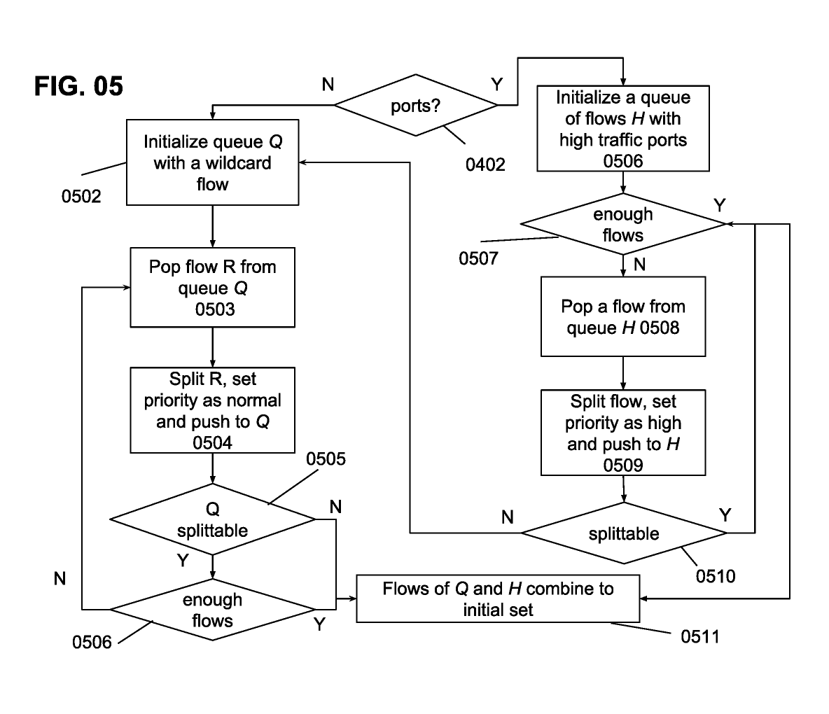

FIG. 06 shows rule generation/assignment during system initialization.

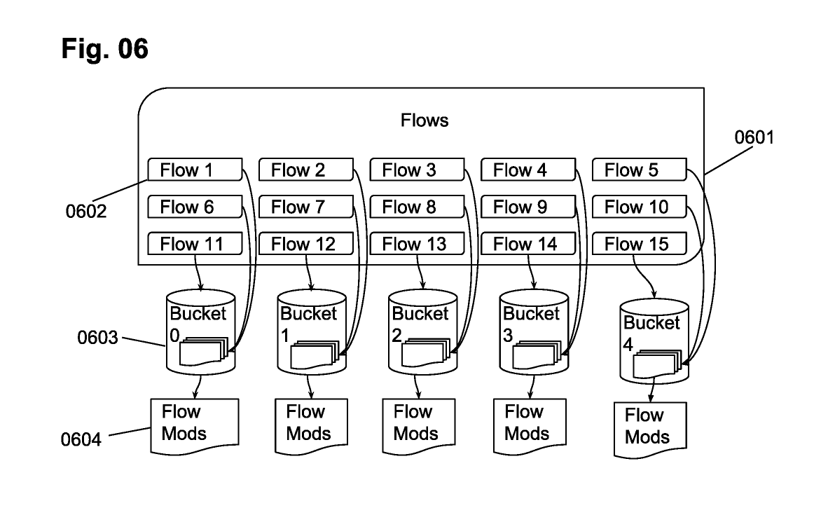

FIG. 07 is a flowchart of the basic shuffle algorithm.

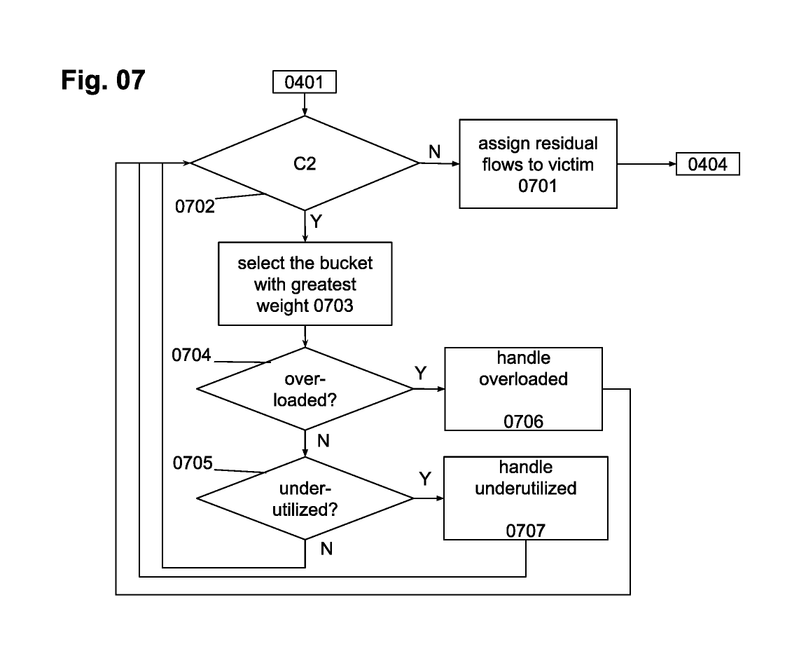

FIG. 08 shows how overload is addressed in normal buckets.

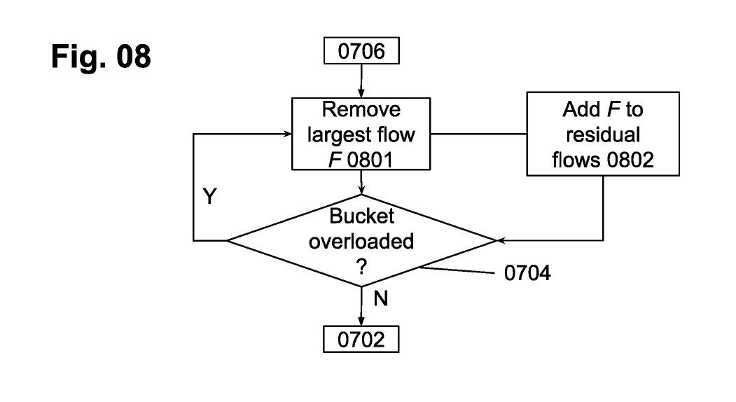

FIG. 09 shows how an underutilized normal bucket is filled closer to its target weight.

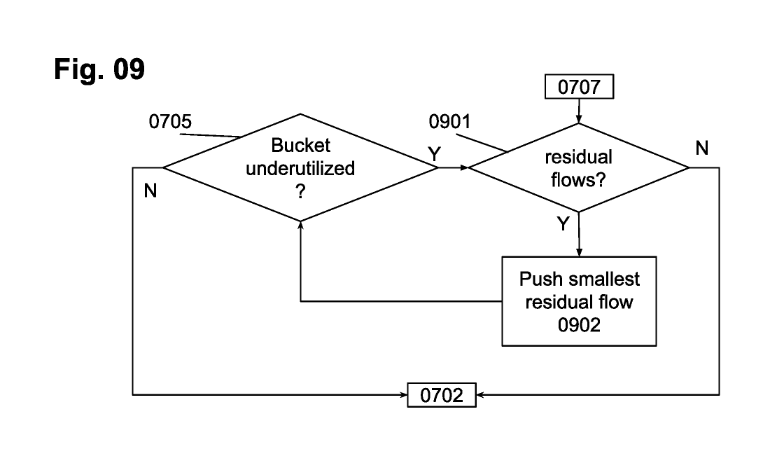

FIG. 10 shows how to fill underutilized normal buckets by taking either full or split flows out of the victim buckets.

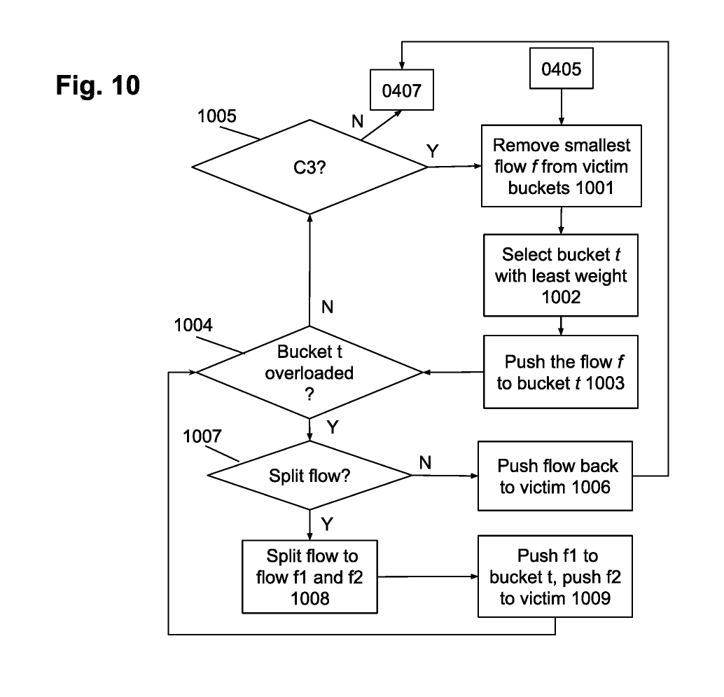

FIG. 11 shows how the victim buckets are rebalanced after some of its flows were split to backfill normal buckets that are not quite loaded to capacity.

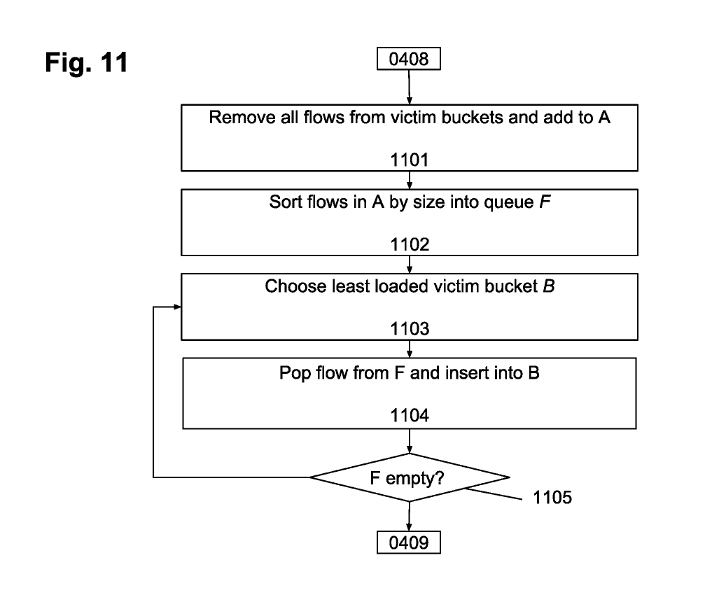

FIG. 12 shows how a reverse flow definition is derived from a forward flow by swapping source and destination addresses.

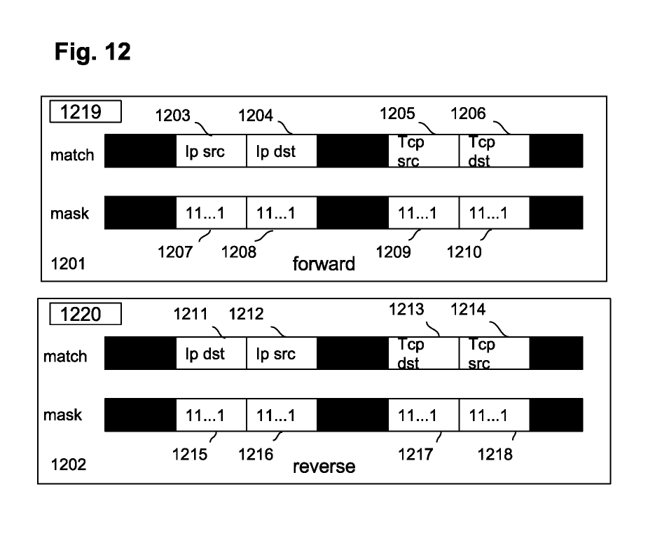

What is claimed is:

1. A method of populating the forwarding table of a packet switch, comprising:
receiving configuration for the switch ports, each classified as either receiving traffic externally or being a target for externally received traffic;
receiving an estimate of traffic capacity estimate for each target port of the switch;
receiving measurements of port statistics for each port of the switch;
receiving measurements of flow statistics for each flow rule installed in said switch;
creating an initial set of flows to be matched;
splitting large a large flow into more specific flows by unmasking flow-bits;
assigning flows to target ports in a manner that balances the amount of traffic flowing to each target port but not to exceed declared traffic capacity estimate for target port;
deriving forwarding instructions in switch-specific configuration language from flow assignments;
installing forwarding instructions in switch to route traffic from receiving ports to target ports;
receiving secondary load measurements from devices receiving forwarded traffic;
dropping of packets belonging to unassigned flows;
redistributing flows previously assigned to one switch target port to a different switch target port reflecting changes in measured statistics since the last assignment choice was made;
redistributing flows from one switch port to another reflecting configuration changes since the last assignment choice was made.

2. The method of claim 1, wherein further configuration for a subset of switch target ports is received to classify some target ports as victim ports to which all flows will be routed that remain unassigned due to capacity limitations;

3. The method of claim 1, wherein weight and capacity are expressed in terms of secondary received load measurements and units;

4. The method of claim 1, wherein a pseudo weight is assigned to each flow resulting from a split of a parent rule of a given weight to be equal to the said weight multiplied by the fraction of parent's flow space that is matched by the child rule.

5. The method of claim 1, wherein special flow forwarding rules of high priority are created for reverse flows matching the forward flows of known protocols such that matching forward and reverse flow are always assigned to the same switch target port.

6. The method of claim 1, wherein capacity as defined by configuration is replaced by an estimate of capacity that is initialized from configuration but reduced at runtime whenever a secondary load measurement signals saturation.

7. The method of claim 1, wherein forwarding rules associate matched packets with an output port and Virtual LAN identifier.

8. The method of claim 1, wherein IP fragments and ICMP packets are forwarded to one or more designated switch target ports not used as targets for any other type of packets other than IP fragments and ICMP packets.

9. The method of claim 1, wherein, prior to installation of forwarding instructions on the packet switch, a plurality of instructions targeting the same switch target port, each matching flows of weight substantially smaller than said port's target capacity, is replaced by a single forwarding instruction with a less restrictive match, which matches a superset of the flows matched by the replaced forwarding instructions, and which forwards to the exact same target port as the replaced forwarding instructions.

10. The method of claim 1, wherein forwarding instructions are generated in OpenFlow format.

11. The method of claim 1, wherein the secondary load measurements include CPU load metrics.

12. The method of claim 1, wherein the secondary load measurements include disk utilization metrics.

13. The method of claim 1, wherein the secondary load measurements include memory utilization metrics.

14. The method of claim 1, wherein the method of generating initial flows includes generating flows that are based on matches with exact bit matches in flow matches for one or more of TCP port 80, TCP port 443, UDP port 53, or TCP port 25.

15. The method of claim 1, wherein the method of generating initial flows includes generating flows that are based on matches that specifically match a plurality of IP addresses associated with well-known video services.

16. The method of claim 1, wherein the method of generating initial flows includes generating flows that are based on matches that specifically match the traffic of an ongoing Denial-of-Service attack.

17. The method of claim 1, wherein a plurality of external ports is connected to both the receive and send passive tap ports of one or more tap device.

18. An apparatus to automatically populate the forwarding table of a packet switch such that the packets of reverse flows are output to the same switch port to which their corresponding forward flows are output, comprising:
A controlled network switch;
A non zero number of ports on said switch on which traffic is received;
A non zero number of ports on said switch on which traffic sent;
A means to specify network traffic flows;
A means to isolate the specification of the source of a network flow;
A means to isolate the specification of the destination of a network flow;
A means to derive a reverse flow from a forward flow by swapping source and destination in the forward flow;
A means to associate to combine a flow specification with switch action into a rule;
A means to preemptively prioritize rule matching and execution in the switch forwarding table;
A means to prevent the installation of duplicate rules in the switch forwarding table;
A means to uniquely identify rules installed in said switch forwarding table;
A means to install new rules on said switch forwarding table;
A means to remove rules from said switch forwarding table;
A means to receive configuration of new and removed rules routes for said switch;
A means to extract the flow specification from a rule;
A means to automatically remove reverse rules when their corresponding forward rule is removed from the switch forwarding table;
A means to automatically insert reverse rules routes when a forward rule is inserted in the switch forwarding table.

19. The apparatus of claim 18, wherein the ports are OpenFlow ports which include tunnel and other logical ports.

20. The apparatus of claim 18, wherein the flows are OpenFlow compatible flows and the Flow-Match-Routes are OpenFlow Flow modifications.

21. The method of populating the forwarding table of a network packet switch such that excessive network flows that overload downstream network devices are routed to one or more victim ports, comprising:
Receiving port configuration of said switch;
Receiving classification of victim ports and non-victim ports;
Receiving classification of upstream and downstream ports;
Receiving configuration of flows in the switch;
Receiving statistics of traffic flows;
Receiving statistics of load induced by forwarded traffic in downstream systems;
Receiving capacity limits for downstream-facing ports on said network switch;
Attributing induced downstream load to flows in the switch;
Sorting said flows by induced downstream load;
Forwarding flows to a victim port;
Comparing downstream-facing port capacity limits with downstream load induced by a flow;
Assigning all flows exceeding downstream-facing ports capacity limits with a forward to victim action;
Deriving switch compatible flow forwarding instructions from flow-assignment;
Installing derived forwarding instructions in the forwarding table of said switch.

22. The method of claim 21, wherein the flows to be reversed are received on the packet switch on upstream ports that connect to the tap port of a passive network tap device.
